(19) United States
(12) Patent Application Publication
(10) Pub. No.: US 2012/0297406 A1
(43) Pub. Date: Nov. 22, 2012

(54) DEVICES, SYSTEMS, AND METHODS FOR SIMULTANEOUSLY DELIVERING PERSONALIZED/ TARGETED SERVICES AND ADVERTISEMENTS TO END USERS

(75) Inventors: William Bartholomay, Orange, CT (US); Sin-Min Chang, Shelton, CT (US); Santanu Das, Fairfield, CT (US); Arun Sengupta, Fairfield, CT (US); Jianxi Dong, West Haven, CT (US); Qi Wang, Bridgeport, CT (US)

(73) Assignee: DOMANICOM CORPORATION, Newton, MA (US)

(21) Appl. No.: 13/450,410

(22) Filed: Apr. 18, 2012

Related U.S. Application Data
(60) Provisional application No. 61/476,583, filed on Apr. 18, 2011.

(51) Int. Cl. H04N 21/80

(52) U.S. Cl. 725/9; 725/34

(57) ABSTRACT

Systems, devices, and methods are disclosed for delivering personalized targeted services and personalized targeted advertisements. The system includes central server providing a one or more services to a customer premises over a communication network. Further, the system includes a home gateway receiving the one or more services from a central server and accessing one or more targeted advertisements thereby delivering the one or more services with the one or more targeted advertisements to a customer premises appliance. Additionally, the system includes one or more set-top boxes receiving the one or more services with the one or more targeted advertisements and delivered to a customer premises appliance and having one or more set-top box software applications supplied by the primary service provider that execute on each set-top box interacting with the central server and home gateway.

### CROSS-REFERENCE OF RELATED APPLICATIONS

The present application claims priority under the laws and rules of the United States, including 35 USC §120, to U.S. Provisional Patent Application No. 61/476,583 filed Apr. 18, 2011. The contents of U.S. Provisional Patent Application No. 61/476,583 are herein incorporated by reference.

### BACKGROUND

There are currently a number of major trends driving the use of the Internet. First, the Internet is used to connect people. The examples include service providers such as Facebook, Myspace, and LinkedIn which connect people to people On a personal level the Internet is used as a communication tool for sending email or files (documents, pictures, images, etc.). Increasingly, the Internet is being used for E-Commerce between business to business or business to consumers. Most recently, Entertainment has become a big driver for the use of the Internet, examples being the introduction of IP-TV services like Netflix, HULU, etc. that can be enjoyed at any time, anywhere. The trend is not only towards any service, anytime anywhere, but also for consumers to have access to more personalized services. Since the access to the Internet and a lot of these services is either free or is inexpensive, the economics of providing these services depends mostly on advertisements. Thus it is imperative that the systems, methods and devices used to provide the services lend themselves to be very effective in not only targeting and personalizing the services but also the advertisements. This invention teaches such systems, methods and devices.

### SUMMARY

Service providers are revolutionizing the way in which they use the Internet to provide services to consumers. Instead of being used to connect only people, the Internet is also being used to connect people to “things” as well as “things” to “things”. For example, a smartphone application may be used to monitor, surveil, or start a vehicle via the Internet. Another example, may be the using a tablet computer application to control a home entertainment center. An example of “things” to “things” is the ability of an energy management server via the Internet to supply a demand/response function by remotely changing a subscriber's thermostat during times of heavy electricity usage. Internet access providers are also evolving from only providing bandwidth to also providing different services with this bandwidth. The trend is not only towards any service, anytime anywhere, but also for consumers to have access to more personalized services. Since the access to the Internet and a lot of these services is either free or is inexpensive, the economics of providing these services depends mostly on advertisements. Thus it is imperative that the systems, methods and devices used to provide the services lend themselves to be very effective in not only targeting and personalizing the services but also in targeting and personalizing the advertisements as well as E-Commerce services like coupon distribution.

Within the embodiments described below, an exemplary system for delivering personalized targeted services and personalized targeted advertisements is disclosed. The system includes central server providing one or more services to a customer premises over a communication network. Further, the system includes a home gateway receiving the one or more services from a central server and accessing one or more targeted advertisements thereby delivering the one or more services with the one or more targeted advertisements to a customer premises appliance. Additionally, the system includes one or more set-top boxes receiving the one or more services with the one or more targeted advertisements and delivered to a customer premises appliance and having one or more set-top box software applications supplied by the primary service provider that execute on each set-top box interacting with the central server and home gateway. A set-top box can be either an IP set-top box or a legacy set-top box.

Moreover, the system includes one or more customer premises appliances (CPE) having one or more appliance software applications supplied by the primary service provider that execute on the CPE appliances interacting with the central server, home gateway and a set-top box. Further, the CPE appliances can include but not limited to, printers, smartphones, tablet computers, desktop computers, laptop computers, televisions, media players, gaming systems, security cameras, energy management devices, home appliances, and combinations thereof and other appliances known in the art.

In addition, the one or more targeted advertisements can be selected from the group consisting of banner advertisements, coupon offers, product insertion, and video advertisements as well as others known in the art. Moreover, the central server stores the one or more targeted advertisements in a remote database and provides the one or more targeted advertisements to the home gateway. Also, the central server schedules each of the targeted advertisements based on a user profile associated with the home gateway wherein the user profile includes user profile information that can be selected from the group consisting of the advertiser's choice of audiences, times, shows, networks, number of per subscriber viewings, synchronization with other advertisements, subscriber's personalized features, geographical information, channel currently selected, personal preferences inputted by a user and learned by a network device including home type, service interests, store rewards programs, commuting weather and traffic information, and schools attended. Further, user profile may include user feature interaction history at the home gateway and at the one or more set-top boxes, favorite choices of programming inputted by user and learned by the network device. Also, the network device can be either a home gateway and a set-top box.

In addition, the home gateway displays the one or more targeted advertisement on a CPE appliance through the one or more set-top box based on the user profile information. Moreover, the home gateway displays the one or more targeted advertisement on the CPE appliance wherein the one or more appliance applications support a set-top box remote control. Further, a user requests more information pertaining to an item in a displayed targeted advertisement such that the information uses the set-top box remote control and the one or more appliance applications. Also, the user engages in one or more user interactions using a simultaneous browser user interface on a main customer appliance by a network device set-top box or home gateway, the user interactions can be selected from the group consisting of retrieve a coupon, conduct e-commerce, search for additional information as well as communication back to the advertiser wherein communication to the advertiser can be selected from the group consisting of social network message, voice message, and instant message. Such messages including social networking, Skype call, VoIP call.

Moreover, the user engages in one or more user interactions using a simultaneous browser user interface on a main customer appliance by a network device (e.g. set-top box or home gateway). The user interactions can be selected from the group consisting of retrieve a coupon, conduct e-commerce search for additional information, communicate back to the advertiser wherein communication to the advertiser can be selected from the group consisting of social network message, voice message, and instant message. Such messages including social networking, Skype call, VoIP call.

The system further includes one or more gateway software applications capable of mining data from digital video or audio content delivered to the one or more CPE appliances. The mining data can be selected from the group consisting of meta data and water-mark information. In addition, the system may include a remote server coupled to the home gateway such that the home gateway retrieves link information and provides such link information to one or more CPE appliances. The link information can be selected from the group consisting of e-commerce opportunities based on the specific information of an individual audio tract or video scene. Link information may also include information of an individual audio track and information of an individual video scene. Moreover, user interactions are monitored and are collected by the home gateway and transmitted to a system server wherein the system server can be selected from the group consisting of the central server or a server of an advertiser.

In addition, the system includes a system server that analyzes the collected user interactions and that provides configuration information; the configuration information can be selected from the group consisting of modifying the scheduling of the one or more targeted advertisements, modifying the user profile based on age and gender of a set-top box user as well as aggregated usage statistics that may include shows watched, advertisements viewed, coupons retrieved, advertisers interacted. Further, usage statistics such as bill to user for on-demand and click on ad then bill to advertiser for billing including paid content watched, paid per view advertising presented, paid advertising interacted with or clicked on and e-commerce conducted as the result of the interaction which may also be billed to advertiser or seller.

The one or more CPE appliances collects user preferences and transmits them to the home gateway that determines customer user information such that the user preferences can be selected from the group consisting of user personalized features, geographical information, current channel selected, personal preferences input by the user that includes home type, service interests, store rewards programs, commuting weather and traffic information, and schools attended, user feature interaction history at the home gateway and a set-top box including scheduled recordings, video and audio library information. In addition, user preferences includes favorite choices for television programming selected by the user and learned by a network device wherein the network device can be selected from a group consisting of a home gateway and a set-top box. Further, the scheduling of time-sensitive applications is modified based on schedule change information, such as a ball game is running past its scheduled allotted time, or a politician speech has interrupted regularly scheduled shows, from a system server. Moreover, the system server can be selected from the group consisting of a central server or a third party server. Moreover, schedule change information includes from the group consisting of meta-data and watermarking, the time-sensitive applications can be selected from the group consisting of recordings, live broadcast events, and advertisements.

Embodiments of the disclosure include a method for delivering personalized targeted services and personalized targeted advertisements. The method includes receiving user input from one or more customer premises appliances at a home gateway to transmit user input to a central server wherein the central server generates a user profile based on user input. In addition, the method includes collecting analytics and user interactions by the home gateway and one or more set-top boxes to transmit the collected analytics and user interactions to the central server. Moreover, the method includes the central server receiving the analytics and user interactions of a user collected by a home gateway and one or more set-top boxes wherein the central server modifies the user profile based on the collected analytics and user interactions. Also, the method includes the central server delivering one or more services with one or more targeted advertisements to a home gateway on a customer premises over a communication network. Further, the method includes a home gateway causing to display the one or more targeted advertisements on a customer appliance. In addition, the method includes the home gateway receiving advertisement user input requesting access to an e-commerce Internet site associated with an item described by the one or more targeted advertisements. Moreover, the method includes the home gateway providing access to the e-commerce Internet site on a customer appliance to allow a user to conduct an e-commerce transaction.

Embodiments of the disclosure include a home gateway for delivering personalized targeted services and personalized targeted advertisements. The home gateway includes one or more processors, one or more storage devices coupled to the one or more processors; one or more communication interfaces coupled to the one or more processors, and one or more software applications executed by one or more processors. The one or more software applications receive user input from a customer appliance through the one or more communication interfaces, receive user profile information, the user profile information generated based on the user input, receive analytics and user interaction information through the one or more communication interfaces.

Further, the one or more software application access one or more targeted advertisements based on an advertisement schedule, cause to display one or more targeted advertisements on a customer appliance receive advertisement user input to access an e-commerce Internet site of an item associated with the one or more targeted advertisements, and providing access to the e-commerce Internet site to a user to conduct an e-commerce transaction for the item. A customer appliance and a customer premises appliance may be used interchangeably in this disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The accompanying drawings, which are incorporated in and constitute part of this specification, illustrate embodiments of the invention and together with the description serve to explain the principles of the present disclosure. The embodiments illustrated herein are presently preferred, it being understood, however, that the invention is not limited to the precise arrangements and instrumentalities shown, wherein:

FIG. 1 shows exemplary network architecture 100 providing multiple services to premises over communication networks;

FIGS. 2-3 is an exemplary functional block diagram of a system for providing personalized services and advertisements to a customer premises 201 over a communication network 202;

FIG. 4 are an exemplary functional block diagrams that shows exemplary functional architecture of a network device that can provide personalized services and targeted/personalized advertisements;

FIG. 5 is an exemplary embodiment illustrating a use of a remote software application on a customer premises appliance;

FIG. 6 is an exemplary embodiment of a screen of a television customer appliance with various regions;

FIG. 7 is an exemplary embodiment illustrating a user of a remote control with a customer premises appliance;

FIG. 8 is an exemplary flowchart of an example method for delivering personalized targeted services and personalized targeted advertisements.

### DETAILED DESCRIPTION

In the following detailed description, reference is made to the accompanying drawings, which for a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of difference configurations, all of which are explicitly contemplated herein. Further, in the following description, numerous details are set forth to further describe and explain one or more embodiments. These details include system configurations, block module diagrams, flowcharts (including transaction diagrams), and accompanying written description. While these details are helpful to explain one or more embodiments of the disclosure, those skilled in the art will understand that these specific details are not required in order to practice the embodiments.

Embodiments of the present disclosure allow primary service providers (those service providers that own, deploy and maintain the equipment) to provide different sets of services to users/consumers by using devices such as a central server, home gateway, and set-top box embodiments of which are described in the present disclosure. The different sets of services are provided either by the primary service provider (e.g. primary services) itself or by secondary service providers (e.g. secondary services that use the primary service provider's network to access a customer's premises). In the case of providing secondary services, a primary service provider relays or facilitates a secondary service from its provider to the user/consumer through its central server. Both primary services and secondary services are provided to a home gateway on a customer premises. The home gateway may then relay or facilitate such services to one or more set-tops and appliances deployed in different locations within the customer premises. Such embodiments allow primary service providers to overcome current market pressures as well as provide a more comprehensive set of services (by itself of by facilitating or relaying secondary services) to users/consumers.

Currently, primary service providers suffer from different market pressures as they provide quadruple play services such as voice (landline), cable TV, Internet access, and wireless/cellular services. For example, service providers that provide Internet access suffer average revenue per user (ARPU) erosion due to competition from cable/satellite and Telco services providers in addition to voice solutions providers such as Vonage and Skype as well as IP TV services such as Hulu, Amazon, and Netflix. Further, a la carte solutions such as Netflix and Hulu cause more ARPU erosion as well as video on demand and pay per view revenue. In addition, the unmanaged delivery of such services creates a bottleneck for Internet access and usage for the primary service provider. Also, currently, service providers cannot target advertisements to individual users or receive useful analytics from the users' behavior. Thus, additional revenue streams are not realized.

Alternatively, the end user suffers from pressure from the service providers. For example, service providers force users to purchase video packages. Empirical data shows that an average user subscribes to 300 channels but only views 12 channels regularly. Further, end customers use point solutions such as TiVo for DVR service or Roku for IP-TV service which must be managed separately from a primary service provider' offered services. However, current set-top boxes do not provide services like IP-TV and do not have the ability to manage these point solutions resulting in a poor user experience. Consequently, users desire not only new services but also the ability to better manage these services. These services include IP TV, streaming video services (e.g. Netflix, Hulu, etc.), simultaneous access to the Internet and television viewing, energy management, surveillance and other services. Further, the users become needless distracted or annoyed with untargeted advertising and crave personalized or targeted advertising and merchandizing.

Embodiments of this disclosure provide systems and devices that provide integrated and/or management of multiple services to customer premises. These services include management of WiFi, IP TV services, management of Sling functions, video game access, surveillance systems, video conference services, electric meter reading, managed DVR functions, local PC backup, social network access, voice services, and future services. Further embodiments may monitor user activity including online, TV and video, music and radio, mobile phone, landline phone, gaming, and electronic reading services. Activities are measured and embodiments provide analytics for such activities. Further, embodiments provide targeted advertising personalized to the user.

Additional embodiments integrates broadcast television, voice over IP, video conferencing over IP, Internet Access and other services over the Internet into a software based management platform using existing broadband infrastructure. Further embodiments integrate smart phones and tablet computers into the managed environment in the premises as envisioned by this disclosure. Other embodiments include data mining and micro-segmentation of the platform the enables targeted advertising and monitoring of user activity of services. In addition, smart phones, tablet computers and personal computers display advertisements that are pushed by either primary or secondary service providers. Embodiments provide individualized solutions that interconnect both people and things over the Internet.

Current business models for primary service providers include an ARPU of $120 for triple play (basic) services such as cable, voice (landline), and Internet services and quadruple play includes cellular. Embodiments allow primary service providers to increase ARPU to $175 per month by providing additional tier 1 services such as managed WiFi service, local and networked IT service with file data backup, key system and fax services for business purposes, video conferencing, and IP TV services. Primary service providers can further increase ARPU to $200 per month by providing tier 2 services from secondary service providers such as local cellular service from Femto Cells, basic and enhanced surveillance services, tele-medicine and e-education services, energy management services, meter reading service and e-commerce with analytics services (to support micro-segmented targeted advertising).

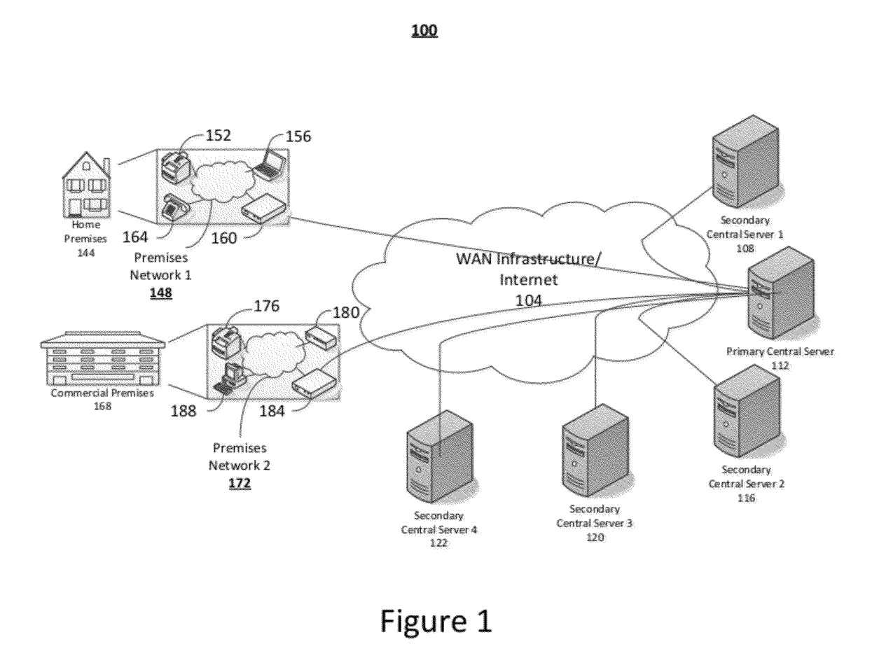

FIG. 1 shows exemplary network architecture 100 providing multiple services to premises over communication networks. The network architecture 100 may include a wide area network (WAN) infrastructure 104 that provides network connectivity over the Internet using communications links between a primary service provider's server (e.g. primary server) 112 and one or more secondary service provider servers (e.g. secondary servers) (108, 116, 120, and 122). A wide area network may be network of nodes or computers whose communication links spans a broad area including crossing metropolitan, regional, national, and continental, political and geographic boundaries. Examples of wide area networks may include the Internet, wireless wide area communication networks, metropolitan area network, cellular networks, and WiMAX networks. The Wide Area Network Infrastructure 104 may include network elements or nodes that facilitate network connectivity between terminal network devices and servers (e.g. primary server, secondary servers, etc.) as shown by the network architecture 100 in FIG. 1. Examples of such network elements or nodes include routers, switches, multiplexers, servers, etc. Communication links between network elements and nodes that are part of the WAN infrastructure such as the communication links between the secondary servers (108, 116, 120, and 122) and the primary server 112 may incorporate packet switching technology, circuit switching technology, or a combination of both. Each of the servers (108, 112, 116, 120, and 122) may be a called a central Server or central server as described in the present disclosure.

In addition to providing network connectivity between the primary server 112 and the secondary servers (108, 116, 120, and 122), the WAN infrastructure 104 provides network connectivity between the primary server and one or more home Gateways (160 and 184). Although FIG. 1 shows the primary server 112 connected to two home gateways (160 and 184), persons of ordinary skill in the art would recognize that the primary server may be connected to additional home gateways. As with the other communication links pictured in FIG. 1, the communication links between the home gateways (160 and 184) and the primary server 112 may incorporate packet switching technology, circuit switching technology, or a combination of both. Further, the exemplary network 100 shows that secondary servers may communicate to end point devices (152, 156, 164, 176, 180, and 188) (e.g. terminal devices) through the WAN infrastructure 104, the primary server 112, one or more home gateways (160 and 184) and one or more premises networks (148 and 172).

Each of the home gateways (160 and 184) reside on customer premises. One home gateway 160 resides in a customer premises 144 and another home gateway 184 resides in a business customer premises 168. The home customer premises 144 may include a premises communication network 148 connecting the home gateway 160 to multiple terminal network or end point devices (152, 156, and 164). Alternatively, the business customer premises 168 may include a premises communication network 172 connecting the home gateway 184 to multiple terminal network or end point devices (176, 180, and 188). Further, each of the home gateways may have multiple communication interfaces supporting different protocols (e.g. USB, Ethernet, Firewire, Bluetooth, WiFi, etc.). One communication interface on each of the home gateways (160 and 184) may be connected to the WAN Infrastructure 104. Another communication interface may be connected to their respective premises networks (148 and 172).

A primary service provider that may own or operate the primary server 112 may be an Internet Service Provider (ISP), for example, or any multi-service operator (MSO) such as a cable television company, a telephone company, or any other company that may also be an ISP. The primary server may provide services to one or more end point devices located on customer premises (144 and 168) over the WAN infrastructure 104. For example, the primary server 112 may provide basic services such as Internet access, voice, cable television, and wireless (WiFi or cellular) services as well as email, network security as well as other types of features or additional tier 1 services. An end point device, such as a personal computer 156 may utilize such services. In addition, secondary service providers may own and operate the secondary servers (108, 116, 120, and 122) to provide their respective services. Secondary service providers may provide additional tier 2 services such as Voice-over-Internet-Protocol (VoIP), energy management, premises security, electronic security, different types of e-commerce, media streaming and storage, etc. In FIG. 1, for example, a secondary server 108 may provide energy management services, another secondary server 116 may provide premises security services, a third secondary server 120, may provide e-commerce services, and a fourth secondary server 122 may provide VoIP services to one or more end point devices (152, 156, 164, 176, 180, and 188).

For example, in the exemplary network 100, end point device 152 and end point device 176 may represent customer premises equipment for a premises (home or office) security service provider. The end point devices (152 and 176) may include sensors and alarms that are located throughout the premises (home 144 or office 168) that provide information to the premises server 116. Another example in the network 100 may be that end point device 156 is a home computer and end point device 188 is an enterprise computer. A primary server 112 may be a server owned and operated by an Internet Service Provider (ISP) or MSO and provide the end point device 156 and end point device 188 with a variety of services such as providing Internet access, email, and network security. Further, a secondary server 120 may be provide e-commerce services such as providing an electronic market place for the users of end point devices (156 and 188) to buy and sell goods. An additional example in network 100 may be that end point device 180 may be a premises energy management system and secondary server 108 may be energy management server. End point device 180 may include different sensors that provide the energy management server 120 with energy consumption and other energy management information for different portions of the office 168. A further example may be that end point device 164 is a VoIP telephone and the secondary server 122 is a VoIP server providing voice telephony services (e.g. telephony, caller identification, voicemail, etc.) to the home 144.

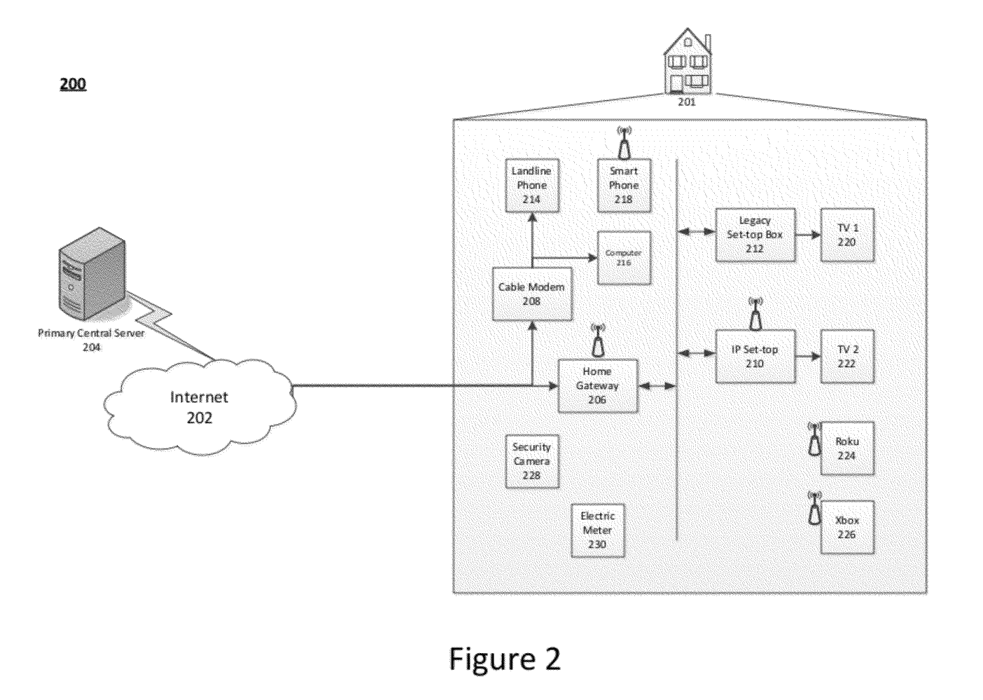

FIG. 2 is an exemplary functional block diagram of a system for providing services to a customer premises 201 over a communication network 202. A primary server 204 provides itself or facilitates/relays services from a secondary server to a customer premises 201. The primary service provider may deliver basic services such as voice, cable television programming, Internet access, and wireless (WiFi or cellular) services to the customer premises. Thus, the primary server 204 is coupled to a home gateway 206 and a cable modem 208 over the communication network (e.g. Internet) 202. The home gateway 206 may also be coupled to a set-up box 212 and set-top 210 over a wired connection such as a local area network (LAN). The primary server delivers basic service to the home gateway 206, cable modem 208, IP set-top box 210, and set-top box 212 to be relayed to end point devices such as landline phone 214, computer 216, TV 1 220, and TV 2, 222. The home gateway 208 may include a wireless router or access point so that it may deliver secondary services to remote devices such as security camera 228 and electric meter 230 over a wireless network. Particularly, the primary server may facilitate/relay surveillance and energy management services from one or more secondary servers through the primary server 204. Further, the home gateway 206 may also be coupled to a smartphone 218 over the wireless network to provide femto cell service within the customer premises. Further, the home gateway 206 may have a wireless transmitter and access point that is coupled to a Roku device 224 and Xbox 226 over a wireless communication network. The primary server 204 may relay secondary services to the Roku 224 and Xbox 226 devices

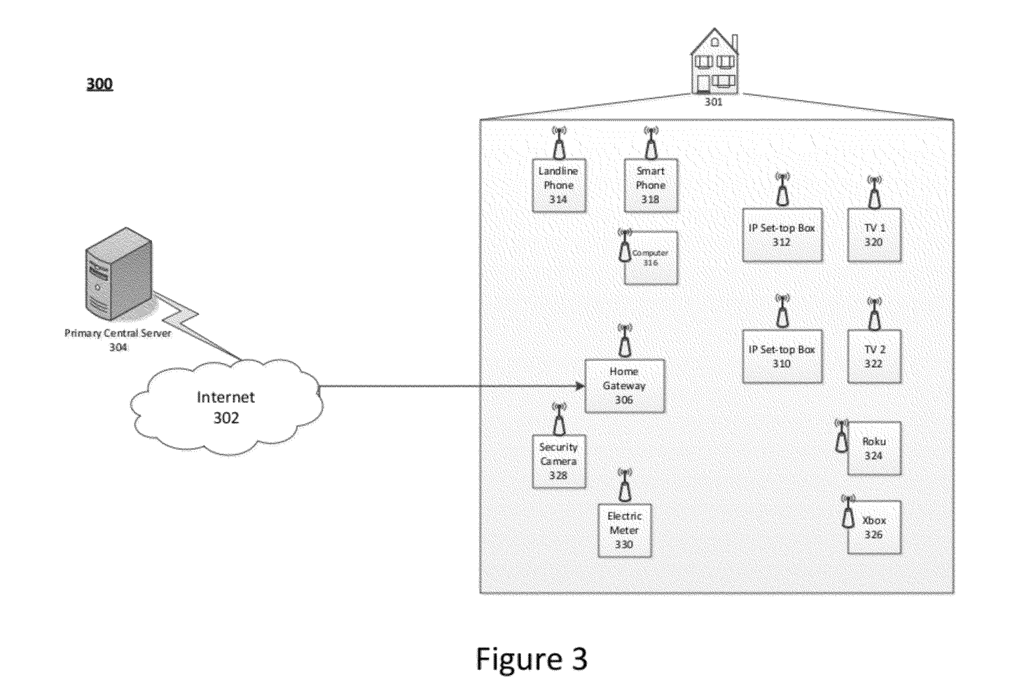

FIG. 3 is an exemplary functional block diagram of a system for providing services to a customer premises 301 over a communication network 302. Further, FIG. 3 shows an evolutionary step where end point devices are coupled to home gateways and set-tops over a wireless network. Thus, the primary server 304 provides primary services or relays secondary servers as in the FIG. 2. However, the home gateway 306 and IP set-top boxes 310 and 312 deliver the services to the end point devices. Further, the home gateway 306 and IP set-top boxes 310 and 312 incorporate functions of the cable modem and/or set-top box described in FIG. 2 so as to reduce the service providing equipment footprint and cabling within the customer premises.

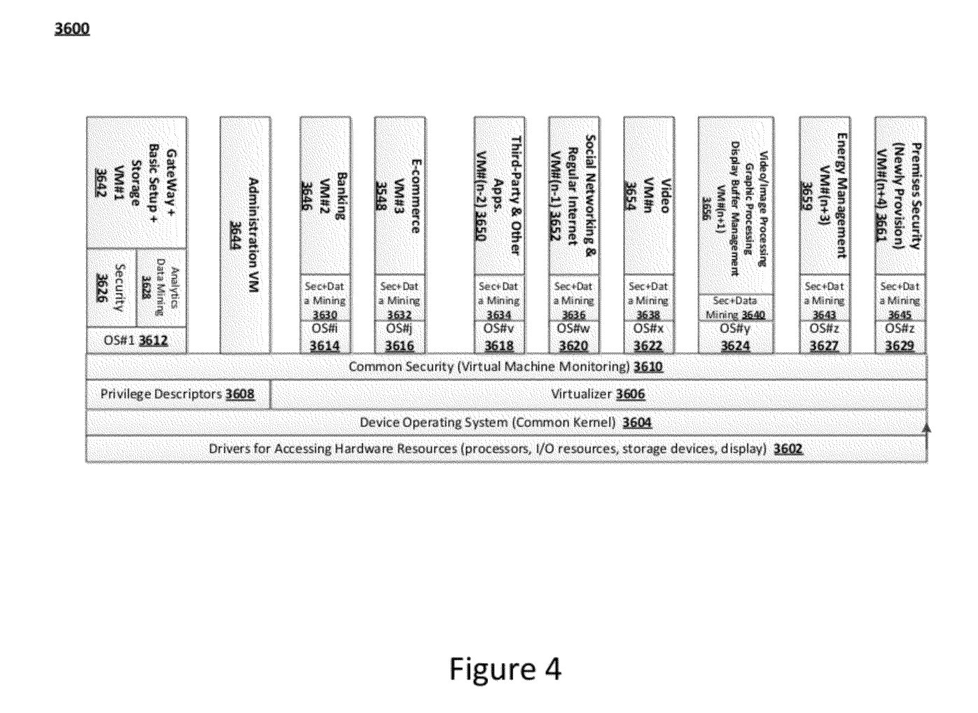

FIG. 4 are an exemplary functional block diagrams that shows exemplary functional architecture of a network device. The network device may be a secondary home gateway server, a primary central server, a home gateway, or an IP set-top box as described in the present disclosure each of which may include all or a subset of the functions and components shown in described in FIG. 4.

The functional block diagram 3600 may include drivers for accessing hardware resources 3602 that may include processors, input/output (I/O) resources, storage devices, display, etc. In addition, the functional block diagram 3600 may include a device operating system (or common operating system) 3604 that may include a common kernel that may control and manage the hardware resources 3602. Also included in the functional block diagram 3600 may be a virtualizer function 3606 and privilege descriptors 3608. Another set of functions in the functional block diagram 3600 may be a common security layer 3610 that includes common security functions as well as virtual machine monitoring function. Further, the functional block diagram 3600 may include one or more virtual machines 3642-3661 implemented by one or more processors of the network device. In addition, each virtual machine may support a service and may include a service operating system 3612-3629 as well as security and data mining functions 3626-3645. The virtualizer function 3606 may generate and configure each virtual machine 3642-3661. The privilege descriptors 3608 may keep track and manage the state or status of the virtual machines 3642-3661. For example, a virtual machine may be in an active state, an inactive, state, a sleep state, a test state, etc. The virtual machine 3644 that supports the network device's administration functions may also assist in managing the functional stacks supported by each virtual machine 3646-3661. This may include receiving and replying test messages from a primary server, secondary server, or an admin terminal to ensure proper function of the updated service or the newly provisioned service.

A network device having the functional architecture 3600 may also have one or more communication interfaces that may include an administrative user interface coupled to an admin terminal. Further, at least one of the communication interfaces may be coupled to a communication network such as a wide area network or a premises network. In addition, the node may have one or more processors and one or more storage devices coupled to the one or more processors. Also, the network device may have one or more software applications stored in the one or more storage devices and executed by the one or more processors. The virtual machines shown in FIG. 4 may be generated and configured by one or more software applications executed by the one or more processors and stored in the one or more storage devices. In addition to each virtual machine having a service operating system and a set of data mining functions, each virtual machine may implement a set of software applications that support a service and a set of security functions that can include crisp logic and/or fuzzy logic security functions.

Further, the common layers (3602-3610) may be generated and configured by one or more software applications executed by the one or more processors and stored in the one or more storage devices. In addition to a common operating system 3604 and a common security layer having virtual machine monitoring functions 3610 that include common security functions, and fuzzy logic security functions. The common security layer may have an inter-virtual machine communication integrity checking function to segregate services among the one or more functional stacks on the network device and to minimize cross-service interference among services supported by one or more functional stacks. Further, the administration function 3644 manages and controls the functional stacks and network operations, and receives and replies to messages from an administration function residing on other network devices (primary server, secondary server) through the communication interfaces. The administration function may include an administration terminal for a network operator to administer the administration function. The administration function residing in the primary server or secondary server may have an associated administration terminal and have the functionality of originating administration messages that include test messages.

Embodiments of the pending disclosure provide further advantages. For example, embodiments offer a single platform that may include one or more central servers, home gateways and IP set-top boxes integrates and manages a multitude of services. Intelligence of an embodiment may be in software that can be field downloadable and upgradeable with new applications. Further, such embodiments have a scalable architecture using virtualization. In addition, embodiments provide security from both external and internal threats. Moreover, security is further tailored per service. In addition, fuzzy logic in conjunction with conventional security in addition to cross-service. Another advantage includes providing data mining, analytics and targeted advertising.

A service provider's current business model may be described as the following. Primary service provider investment in equipment includes one node per subscriber, one set-top box per TV, service provider server with a software license for up to 20,000 subscribers. Such total investment may be comparable with multi-room DVR deployment. Primary service provider revenue streams from current business model include monthly charges for video services and rental charges for premises equipment.

Alternatively, by deploying the disclosed embodiments, the primary service provider's investment in equipment may be one home gateway per subscriber, one IP set-top box per TV, a central server software license per 20,000 subscribers, an annual software maintenance contract per 20,000 subscribers, total equipment revenue per subscriber equivalent to multi-room DVR deployment. Additional revenue streams from enhanced business model may include revenue sharing from micro-segmented local advertisement, a portion of banner advertisement (per view and per click), portion of e-commerce revenue sharing resulting from access via banner clicks, portion of expense saving from targeted clip-less e-coupon delivery, portion of expense savings from account and service alerts revenue, revenue sharing from other secondary service providers, portion of monetization of analytics through primary service provider sharing with third parties. Such embodiments provide a business model that includes revenue from equipment and revenue from services.

Additional embodiments include implementation of synchronized screen. This includes multiple screens enabled for viewing on a single display from the set-top, main screen is the tuned or IP TV stream selected, additional screens can be banners, browser windows, application windows, etc., user can select a full screen or multiple screen mode. Further embodiments include synchronized operation by taking the information about the selected main stream content and accessing the associated Web site (e.g. ESPN.com if ESPN is being watched) or other third party supplied web site. The side screen is used to present selections that permit the user to search for information relative to the playing asset. For example, producer, actors, players, products placed, relevant advertising, etc. Additional embodiments include reactive embodiments that include the user can use the remote or a smart phone application being used as a super remote to navigate and select items of interest thus displaying additional information. Further, based on analytics related to a user and the current viewed asset, micro-segmentation is used to target either banner or local spliced advertising. In addition, this information can be extended to printing or downloading coupons and to making purchases.

Other embodiments include implementation of banner advertising/coupons. Banner advertisements include the Banner appearing as a targeted caption at the bottom of the screen; this also enables one remote control button or a corresponding smart phone app for responding to the banner for ‘click’. Further, ‘Click’ opens a side window on the main display screen with information relative to the banner advertisement. In addition, this side window will also open to a smart phone if enabled. Moreover, the remote or the smart phone can be used to retrieve information, make a purchase or to record/print a coupon. Coupons include the service provider shares analytics with a coupon service provider like Groupon which is used by the primary service provider to better target coupons to users. Further, a coupon gets ‘pushed’ onto the main screen like a banner through the internet connection i.e. a VPN connection to the coupon service provider's server. In addition, if the user wants the coupon he ‘clicks’ his remote or smart phone. Depending on user's equipment, the coupon can be sent to a user's printer or to his smart phone. A successful completion is recorded when the coupon is redeemed. Other embodiments include synchronized banner/coupon. This may be done by an advertising /e-commerce agency in an active advertisement in concert with the content provider. For example, an actress may be wearing a dress in a specific scene in a movie or episode, a synchronized ad can appear as a banner or window. Clicking the banner may initiate the same sequence of interaction and purchase scheme as described above. The system will work as a search engine with the context (meta data or watermark) being supplied by the content provider such that a user can obtain information, make purchases and otherwise interact with products placed in the content. Monetization of such services may be considered an extension of the present product placement model used currently. Other interactive services include improved targeting of services and advertising through analytics as well as interaction through on demand opening of ‘windows’ and interaction including recording of successful events as above. The set-top box can be an IP set-top box or legacy or conventional set-top box.

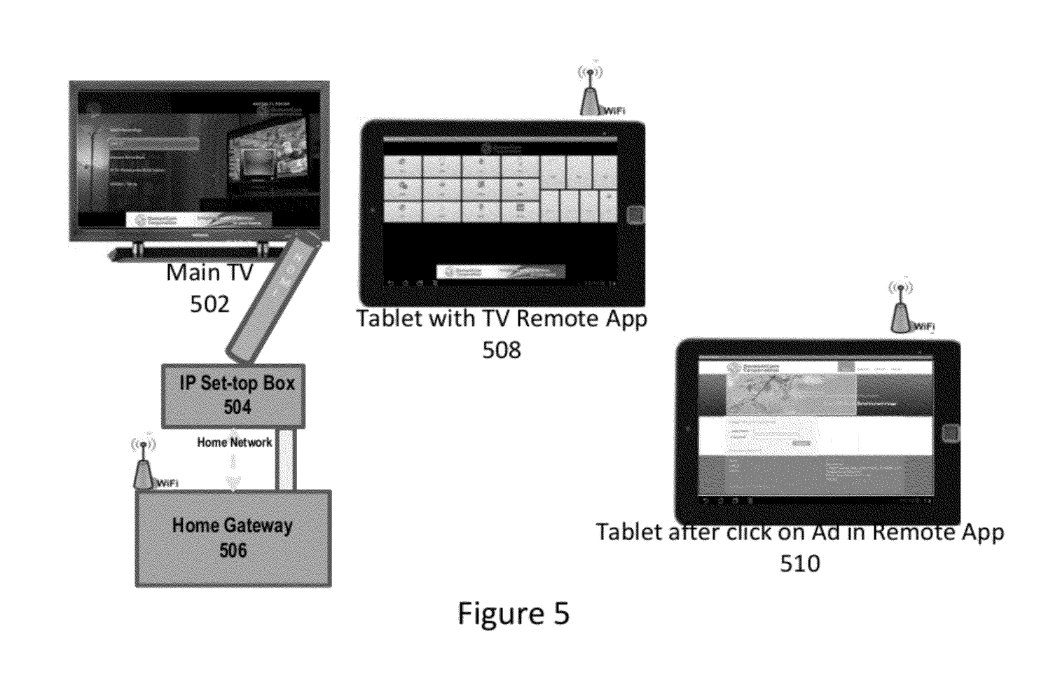

FIG. 5 is an exemplary embodiment illustrating a use of a remote software application on a customer premises appliance. A main television 502 is displaying a video content with a targeted advertisement across the bottom of the main television 502 screen. The video content is provided by a central server (not shown) through a home gateway 506 and an IP set-top box 504 to the main television 502. The home gateway 506 may have a wireless access point. Further, a TV remote control software application running a customer appliance such as a tablet computer 508. The tablet computer may be coupled wirelessly to the home gateway so that the tablet computer may be able to control the video content display on the main television 502. One function on the remote control application on the tablet computer 508 may be allowing the user to click on the targeted banner advertisement displayed below the video content of the Main TV 502 which is also displayed on the Tablet. After the user doing so, the tablet computer may display an e-commerce website in a private browser user interface on the tablet computer as shown in 510 that allows the user to purchase the advertised good or service, communicate with the advertiser such as to get additional information or vote for a preference requested by the advertiser.

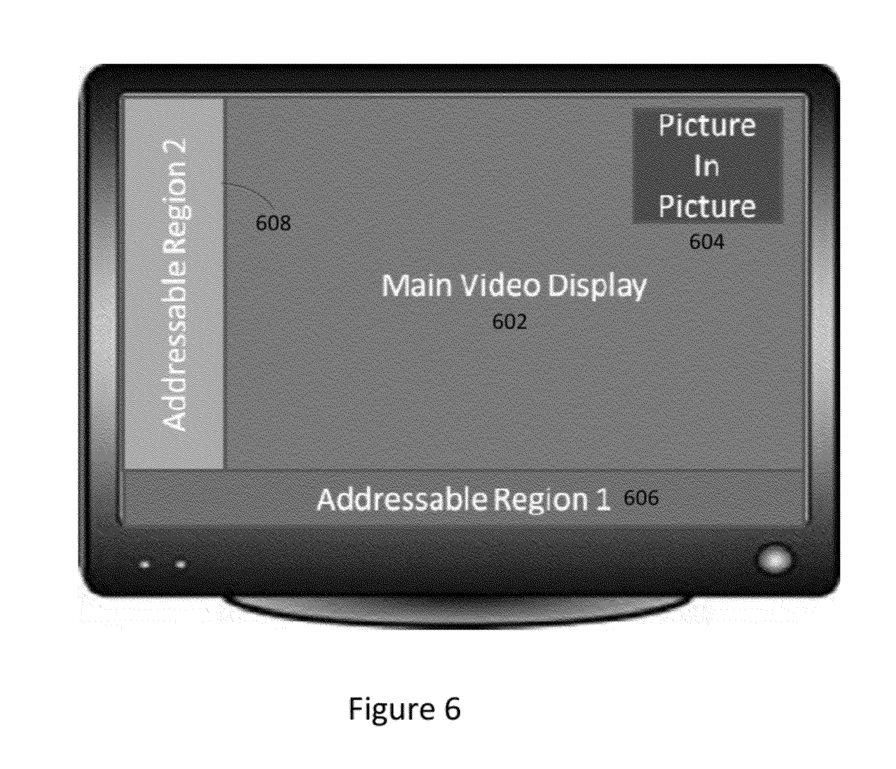

FIG. 6 is an exemplary embodiment of a screen of a television customer appliance with various regions. In exemplary television screen may be partitioned in four regions. A main video display 602 may show video content to a user. However, if the user requests to see channel guide information (or a surveillance camera) then the video content may be shown in the picture in picture region 604. Further, there may be an addressable region 1 606 and addressable region 2 608. Addressable region 606 may display a targeted banner advertisement or coupon. Further, addressable region 608 may have an internet browser that can be used to navigate to an e-commerce website based on the good or service advertised in the targeted banner advertisement and coupon.

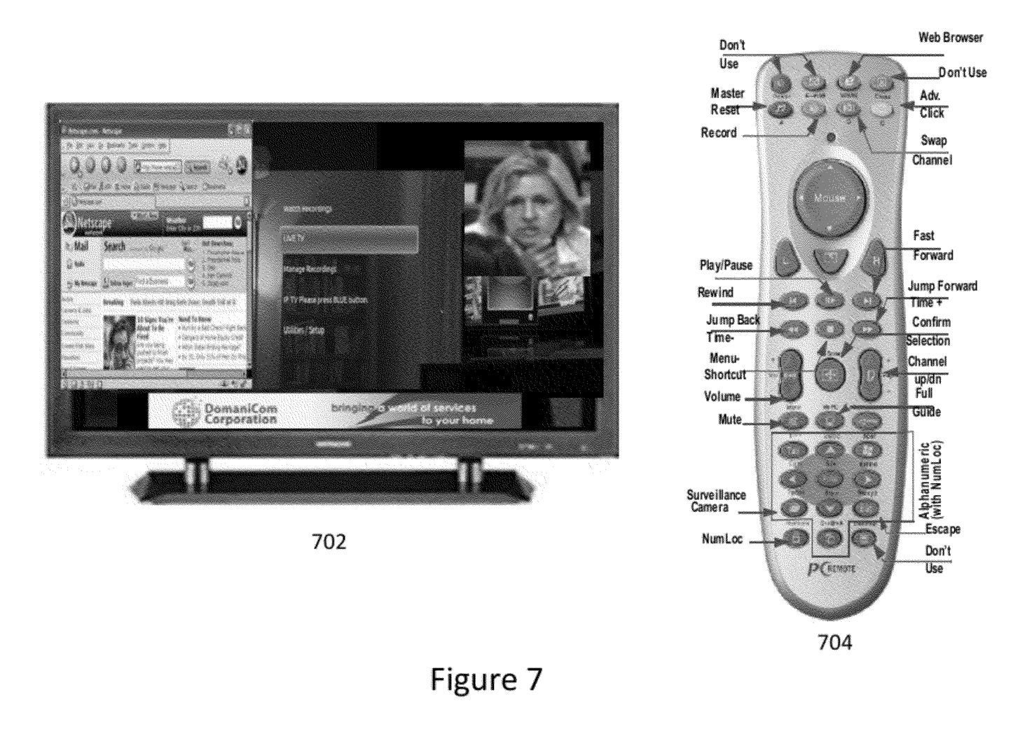

FIG. 7 is an exemplary embodiment illustrating a user of a remote control 704 with a customer premises appliance 702. The remote control 704 controls a customer appliance that is a television 702. The remote control 702 may control several different regions on the screen of the television 702. This may be done directly by the television or it may the application running on the set top box, 504 in FIG. 5, that controls the television. For example, a web browser button enables browser to be in addressable region 2 with context based on user analytics. Such a browser may be toggled to be shown in the main video display. Further, if a target advertisement is shown in addressable region 1, the Adv. Click button registers the event and can trigger browser to display e-commerce content.

In and alternative embodiment, if television screen display video content only with no targeted advertisement, then a user pressing the Adv. Click button triggers meta data/watermark search software in home gateway to e-commerce content in the browser in addressable region 2. A further embodiment includes the Surveillance Camera button toggles to picture in picture of last motion detected camera.

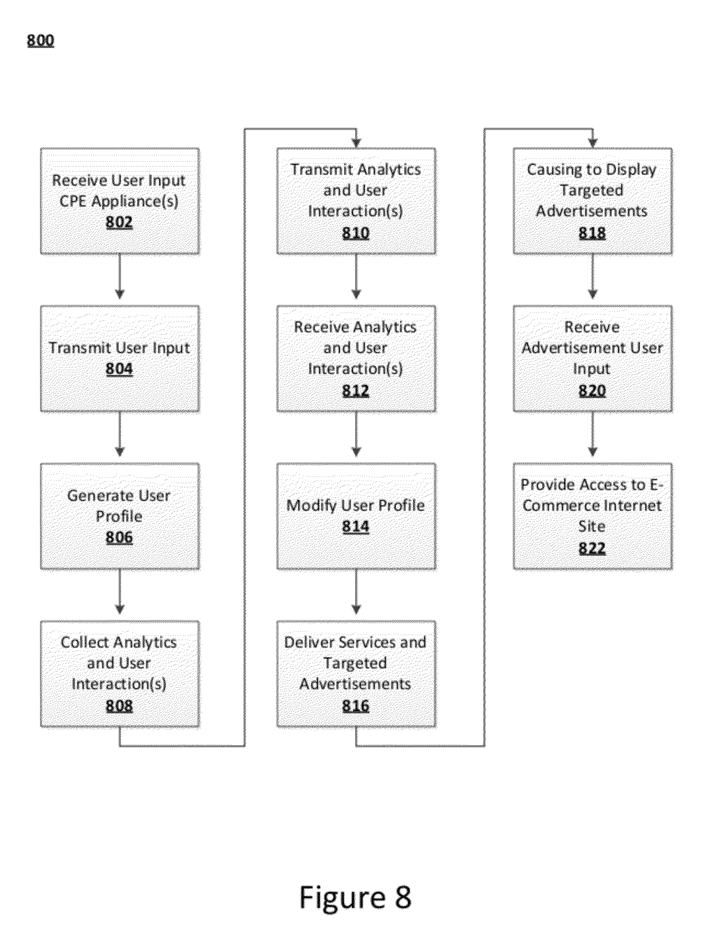

FIG. 8 is an exemplary flowchart of an example method for delivering personalized targeted services and personalized targeted advertisements. A first step in the example method may be receiving user input from one or more customer premises appliances at a home gateway, as shown in block 802. A further step may be transmitting user input to a central server, as shown in block 804. An additional step may be generating a user profile, by the central server, based on user input, as shown in block 806. Another step may be collecting analytics and user interactions by the home gateway and one or more set-top boxes, as shown in block 808. Also, the method may include transmitting, by the home gateway, the collected analytics and user interactions to the central server, as shown in block 810. A further step may be receiving, by the central server, the analytics and user interactions of a user collected by a home gateway and one or more set-top boxes, as shown block 812. An additional step may be modifying the user profile, by the central server, based on the collected analytics and user interactions, as shown in block 814. Another step may be delivering, by the central server, one or more services with one or more targeted advertisements to a home gateway on a customer premises over a communication network, as shown in block 816. The method also includes a home gateway causing to display the one or more targeted advertisements on a customer appliance, as shown in block 818. A further step may be the home gateway receiving advertisement user input the advertisement user input requesting access to an e-commerce Internet site associated with an item described by the one or more targeted advertisements, as shown in block 820. An additional step may be the home gateway providing, by the home gateway, access to the e-commerce Internet site on a customer appliance in block 822 to allow a user to conduct an e-commerce transaction.

Persons of ordinary skill in the art would understand that the examples described in the present disclosure are illustrative and not limiting and that the concepts illustrated in the examples may be applied to other examples and embodiments.

Note that the functional blocks, methods, devices and systems described in the present disclosure may be integrated or divided into different combination of systems, devices, and functional blocks as would be known to those skilled in the art.

In general, it should be understood that the circuits or functions described herein may be implemented in hardware using integrated circuit development technologies, or yet via some other methods, or the combination of hardware and software objects that could be ordered, parameterized, and connected in a software environment to implement different functions described herein. For example, the present application may be implemented using a general purpose or dedicated processor running a software application through volatile or non-volatile memory. Also, the hardware objects could communicate using electrical signals, with states of the signals representing different data.

It should be further understood that this and other arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions, or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

We claim:

1. A system for delivering personalized targeted services and personalized targeted advertisements, comprising:
(a) central server providing a one or more services to a customer premises over a communication network;
(b) home gateway receiving the one or more services from a central server and accessing one or more targeted advertisements thereby delivering the one or more services with the one or more targeted advertisements to a customer premises appliance;
(c) one or more set-top boxes receiving the one or more services with the one or more targeted advertisements and delivered to a customer premises appliance and having one or more set-top box software applications supplied by the primary service provider that execute on each set-top box interacting with the central server and home gateway.

2. The system of claim 1, further comprising one or more customer premises appliances (CPE) having one or more appliance software applications supplied by the primary service provider that execute on the CPE appliances interacting with the central server, home gateway and an set-top box.

3. The systems of claim 2, wherein the CPE appliances can be selected from the group consisting of printers, smartphones, tablet computers, desktop computers, laptop computers, televisions, media players, gaming systems, security cameras, energy management devices, home appliances, and combinations thereof.

4. A system of claim 1, wherein the one or more targeted advertisements can be selected from the group consisting of banner advertisements, coupon offers, product insertion, and video advertisements.

5. The system of claim 1, wherein the central server stores the one or more targeted advertisements in a remote database and provides the one or more targeted advertisements to the home gateway.

6. A system of claim 5 wherein the central server schedules each of the targeted advertisements based on a user profile associated with the home gateway wherein the user profile includes user profile information that can be selected from the group consisting of:
a. The advertiser's choice of audiences, times, shows, networks, number of per subscriber viewings, synchronization with other advertisements;
b. Subscriber's personalized features;
c. Geographical information;
d. Channel currently selected;
e. Personal preferences inputted by a user and learned by a network device including home type, service interests, store rewards programs, commuting weather and traffic information, schools attended;
f. user feature interaction history at the home gateway and at the one or more set-top boxes;
g. favorite choices of programming inputted by user and learned by the network device;
h. wherein the network device can be selected from the group consisting of a home gateway and a set-top box.

7. A system of claim 6, wherein the home gateway displays the one or more targeted advertisement on a CPE appliance through the one or more set-top box based on the user profile information.

8. A system of claim 2 wherein the home gateway displays the one or more targeted advertisement on the CPE appliance wherein the one or more appliance applications support a set-top box remote control.

9. A system of claim 1, wherein a user requests more information pertaining to an item in a displayed targeted advertisement such that the information uses the set-top box remote control and the one or more appliance applications.

10. A system of claim 6 wherein the user engages in one or more user interactions using a simultaneous browser user interface on a main customer appliance by a network device, the user interactions can be selected from the group consisting of:
a. Retrieve a coupon;
b. Conduct E-Commerce;
c. Search for additional information;
d. Communicate back to the advertiser wherein communication to the advertiser can be selected from the group consisting of social network message, voice message, and instant message.

11. The system of claim 6, wherein the user engages in one or more user interactions using a simultaneous browser user interface on a main customer appliance by a network device, the user interactions can be selected from the group consisting of:
a. Retrieve a coupon
b. Conduct E-Commerce
c. Search for additional information
d. Communicate back to the advertiser wherein communication to the advertiser can be selected from the group consisting of social network message, voice message, and instant message.

12. A system of claim 2, further comprising one or more gateway software applications capable of mining data from digital video or audio content delivered to the one or more CPE appliances wherein the mining data can be selected from the group consisting of meta data and water-mark information.

13. A system of claim 11, further comprising a remote server coupled to the home gateway such that the home gateway retrieves link information and provides such link information to one or more CPE appliances, the link information can be selected from the group consisting of:
a. e-commerce opportunities based on the specific information of an individual audio tract or video scene
b. information of an individual audio track
c. information of an individual video scene

14. A system of claim 11, wherein the user interactions are monitored and are collected by the home gateway and transmitted to a system server wherein the system server can be selected from the group consisting of the central server or a server of an advertiser.

15. A system of claim 14, wherein a system server analyzes the collected user interactions to provide configuration information, the configuration information can be selected from the group consisting of:
a. modifying the scheduling of the one or more targeted advertisements.
b. modifying the user profile based on age and gender of a set-top box user;
c. aggregated usage statistics that may include shows watched, advertisements viewed, coupons retrieved, and advertisers interacted.
d. usage statistics for billing including paid content watched, paid per view advertising presented, paid advertising interacted with or clicked on and e-commerce conducted as the result of the interaction.

16. A system of claim 1 wherein the one or more CPE appliances collects user preferences and transmits to the home gateway that determines customer user information such that the user preferences can be selected from the group consisting of:
a. user personalized features
b. geographical information
c. current channel selected
d. personal preferences input by the user that includes home type, service interests, store rewards programs, commuting weather and traffic information, and schools attended;
e. user feature interaction history at the home gateway and a set-top box including scheduled recordings, video and audio library information;
f. favorite choices for television programming selected by the user and learned by a network device wherein the network device can be selected from a group consisting of a home gateway and a set-top box.

17. The system of claim 15, wherein:
the scheduling of time-sensitive applications is modified based on schedule change information from a system server;
the system server can be selected from the group consisting of a central server or a third party server;
schedule change information includes from the group consisting of meta-data and watermarking;
the time-sensitive applications can be selected from the group consisting of recordings, live broadcast events, and advertisements.

18. A method for delivering personalized targeted services and personalized targeted advertisements, comprising:
receiving user input from one or more customer premises appliances at a home gateway to transmit user input to a central server wherein the central server generates a user profile based on user input;
collecting analytics and user interactions by the home gateway and one or more set-top boxes to transmit the collected analytics and user interactions to the central server;
receiving, by the central server, the analytics and user interactions of a user collected by a home gateway and one or more set-top boxes wherein the central server modifies the user profile based on the collected analytics and user interactions;
delivering, by the central server, one or more services with one or more targeted advertisements to a home gateway on a customer premises over a communication network;
causing to display, by a home gateway, the one or more targeted advertisements on a customer appliance;
receiving advertisement user input by the home gateway, the advertisement user input requesting access to an e-commerce Internet site associated with an item described by the one or more targeted advertisements;
providing, by the home gateway, access to the e-commerce Internet site on a customer appliance to allow a user to conduct an e-commerce transaction.

19. A home gateway for delivering personalized targeted services and personalized targeted advertisements comprising:
one or more processors,
one or more storage devices coupled to the one or more processors;
one or more communication interfaces coupled to the one or more processors;
one or more software applications executed by one or more processors, the one or more software applications: (i) receiving user input from a customer appliance through the one or more communication interfaces; (ii) receiving user profile information, the user profile information generated based on the user input; (iii) receiving analytics and user interaction information through the one or more communication interfaces.

20. The home gateway of claim 19, wherein the one or more software application: (i) access one or more targeted advertisements based on an advertisement schedule; (ii) cause to display one or more targeted advertisements on a customer appliance; (iii) receive advertisement user input to access an e-commerce Internet site of an item associated with the one or more targeted advertisements; (iv) providing access to the e-commerce Internet site to a user to conduct an e-commerce transaction for the item.
